(19) United States
(12) Patent Application Publication
(10) Pub. No.: US 2011/0244357 A1
(43) Pub. Date: Oct. 6, 2011

(54) Electrocatalyst Composition And Fuel Cell Containing Same

(75) Inventors: John J. Rusek, West Lafayette, IN (US); Donald Bower, West Lafayette, IN (US); Richard Meyer, West Lafayette, IN (US); Mark L. Daroux, Cleveland, OH (US); Wanjung Fang, Cleveland (OH)

(73) Assignee: SWIFT ENTERPRISES, LTD., West Lafayette, IN (US)

(21) Appl. No.: 13/133,594

(22) PCT Filed: Aug. 27, 2010
(86) PCT No.: PCT/US10/46912

§ 371 Date: Jun. 8, 2011

Related U.S. Application Data
(60) Provisional application No. 61/237,550, filed on Aug. 27, 2009.

(51) Int. Cl. H01M 4/90; H01M 8/10

(52) U.S. Cl. 429/480; 429/523; 429/531; 429/524; 429/525; 429/526; 429/527

(57) ABSTRACT

An electrocatalyst composition comprising one or more electrically conductive particles of one or more of carbon black, activated carbon, and graphite with one or more catalysts of a macrocycle and a metal adhered and/or bonded to the outer surface of the particles. The catalyst can be comprised, for example, of one or more of acetylacetonate and phthalocyanine and a metal. The metal component used in the electrocatalyst composition is comprised of one or more of iron, nickel, zinc, scandium, titanium, vanadium, chromium, copper, platinum, ruthenium, rhodium, palladium, silver, osmium, iridum, platinum and gold. An ionic transfer membrane having a layer of the electrocatalyst thereon is disposed in a fuel cell in communication with and between current collectors.

### REFERENCE TO A RELATED APPLICATION

This International Application claims the benefit of U.S. Provisional Application No. 61/237,550, filed Aug. 27, 2009, the contents of which are incorporated herein by reference.

### BACKGROUND OF THE INVENTION

1. Field Of The Invention

The present invention relates generally to an electrocatalyst composition such as electrocatalyst powders used in the fabrication of energy devices such as fuel cells, and more particularly, to fuel cells containing the improved electrocatalyst compositions of the present invention.

2. Description Of Related Art

A fuel cell is similar to other electrochemical cells in which there is an electrolyte (e.g., liquid or solid) and two electrodes (e.g., a cathode and an anode) at which the electrochemical reaction occurs. The fuel cell is distinguished from a conventional battery by its fuel storage capacity and the fact that the electrodes are catalytically active. The fuel cell is used to convert stored energy in a fuel (e.g., hydrogen gas or methanol) into electrical energy.

The electrochemical reactions of the fuel cell required for the conversion include oxidation of the fuel (e.g., hydrogen or methanol) at the anode and reduction of an oxidant at the cathode. As the fuel is oxidized at the anode, electrons are given up to an external electrical load and the oxidant (e.g. oxygen) accepts electrons and is reduced at the cathode. Ionic current flowing through an electrolyte completes the circuit.

As a result of the nature of these reactions, it is necessary that the electrodes are designed to allow gaseous reactants and/or products to defuse into and/or out of the electrode structures. These electrodes are specifically designed to be porous to allow fluid diffusion and maximize the contact between the reactants and the electrode to optimize the reaction rate. Such porous electrodes are commonly used in a membrane electrode assembly (hereinafter referred to as “MEA”), which is typically made of an ionically conducting polymeric membrane sandwiched between two electronically conducting electrodes.

The electrolyte is required to be in contact with both electrodes, can be either acidic or alkaline, and takes the form of a solid or a liquid depending on the particular application. For example, in a proton-exchange membrane fuel cell, the electrolyte is a solid proton-conducting polymer membrane. Generally, the polymer electrolyte must remain hydrated during operation in order to prevent loss of ionic conduction. As a result of the necessity for hydration, the upper limits of the operating temperature is usually between 70°-120° C.

The relatively low operating temperatures of fuel cells require the use of electrocatalysts in order for the oxygen reduction and hydrogen oxidation reactions to proceed at useful rates. Noble metals, particularly platinum, have been found to be the most efficient and stable electrocatalysts for hydrogen oxidation in low temperature fuel cells. Noble metal catalysts are frequently provided in the form of dispersed small particles having a large surface area to volume ratio. These particles may be distributed on and supported by larger conducting carbon particles to provide a desired catalyst loading. It has been found that these platinum catalysts are severely retarded in their reaction kinetics by carbon monoxide concentrations of only a few parts per million.

One major obstacle to the development of platinum containing catalytic electrodes for electrochemical reactions is the cost of the platinum metal. Another major obstacle is the loss of electrochemical activity due to poisoning of the catalyst by carbon monoxide. The CO molecule is strongly adsorbed on the electroactive surface of the electrode which obstructs oxidation of new fuel molecules.

Various unsuccessful attempts have been made to find a solution to the CO poisoning problem; however, results have been proven to be too expensive, insufficiently effective or too impractical to be commercially viable.

Current approaches in the art have yielded some materials that have improved electrocatalytic activities and are less expensive than pure platinum catalysts. However, the costs associated with these materials are still prohibitive for full exploitation in fuel cell technology. Other approaches are to completely remove platinum from these systems and replace it with less expensive materials while retaining catalytic activity at least equal to that of platinum.

U.S. Pat. No. 7,498,286 discloses electroreduction of oxygen with non-platinum metallic combinations, as well as the use of inorganic and organometallic complexes, transition metal oxides, calchogenides, and enzyme electrodes. Despite the extensive research that has been carried out in this area, the detailed mechanism of the oxygen reduction reaction ORR, even at Pt, is still uncertain.

The foregoing problems have been recognized for many years and while numerous solutions have been proposed, none of them adequately address all of the problems in a single device.

U.S. Pat. No. 7,476,459 discloses a membrane electrode assembly for use in a fuel cell in which the membrane electrode assembly includes an anode, cathode and a solid polymer electrolyte membrane interposed between the anode and cathode. The anode and cathode include gas diffusion layers and electrode catalyst layers. The electrode catalyst layers and adhesive layers can be mixed in the mixture layers.

U.S. Pat. No. 7,507,687 discloses composite electrocatalyst particles wherein a metal or a metal oxide is dispersed on a support phase, such as carbon or a metal oxide. Various combinations of carbons, metals, metal alloys, metal oxides, mixed metal oxides, organometallic compounds and their partial pyrolysis products can be used. As an example, combinations of Ag and Mn supported on carbon is useful for some electrocatalytic applications. Also disclosed are further classes of catalysts including metal porphyrin complexes of Co, Fe, Zn, Ni, Cu, Pd, Pt, Sn, Mo, Nn, Os, Ir, and Ru. Such metal ligands can be selected from the class of N4-metal chelates, represented by porphyrins, tetraazaanulens, phyalocyanines and other chelating agents. In one embodiment, there is disclosed that the carbon particles or electrocatalytic particles are polymer-modified with a polymer, for example, a tetrafluoroethylene fluorocarbon polymer such as TEFLON, or a proton conducting polymer such as a sulfonated perfluorohydrocarbon polymer such as NAFION.

The above conventional electrocatalyst materials, however, experience various drawbacks, such as CO poisoning. It is therefore an object of the present invention to provide an improved fuel cell electrocatalyst composition that is more resistant to CO poisoning which can be used in fuel cells.

It is therefore another object of the present invention to provide an electrocatalyst for fuel cells which retains acceptable electrocatalytic activity while being resistant to CO poisoning.

It is yet another object of the present invention to provide an electrocatalyst composition which is less expensive than pure Pt or related noble metal catalysts.

It is another object of the present invention to provide a fuel cell membrane electrode assembly which can effectively utilize the improved electrocatalyst of the present invention.

### SUMMARY OF THE INVENTION

The present inventors recognized a need for electrodes that retain acceptable electrocatalytic activity, while providing abundant, inexpensive, and efficient electrocatalytic materials which are alternatives to pure Pt catalysts. Accordingly, the present inventors carried out extensive research and unexpectedly discovered a new and improved fuel cell electrocatalyst composition designed to overcome the above-described problems and which can be used effectively in a fuel cell.

The present inventors discovered a fuel cell electrocatalyst composition comprised of one or more electrically conductive particles with one or more catalysts adhered and/or bonded to the outer surface of the particles. The catalyst is comprised of a macrocycle and a metal which may be incorporated in a polymeric binder. Although any type of macrocycle can be used, it is preferred to employ a macrocycle defined as a cyclic molecule with three or more potential donor atoms that can coordinate to a metal center. These macrocycles can be synthesized using conventional synthesis routes described in the literature. See International Union of Pure and Applied Chemistry. “macrocycle”. Compendium of Chemical Terminology Internet Edition.

Preferably, the catalyst comprises one or more of acetylacetonate and phthalocyanine which is complexed or mixed with one or more metals such as iron, nickel, zinc, scandium, titanium, vanadium, chromium, copper, platinum, ruthenium, rhodium, palladium, silver, osmium, iridium, platinum and gold. The complexing of the macrocycle with the metal can be accomplished using any of the conventional processes described in the literature.

The fuel cell electrocatalyst composition of the present invention can be incorporated in a fuel cell membrane electrode assembly comprising an anode, a cathode disposed opposite the anode, and a fuel cell membrane disposed between the anode and the cathode. The membrane electrode assembly preferably comprises a membrane having one or more of its surfaces coated with, or otherwise in contact with a layer of the electrocatalyst composition of the present invention. In a preferred embodiment, the electroconductive particles and the catalyst comprised of a macrocycle and metal are incorporated in a polymeric binder which can be applied as a coating to one or more layers of the MEA disposed between the cathode and anode. The MEA can comprise 5 layers: a porous carbon layer, a coating of catalyst preferably applied to this carbon substrate, a membrane, the other catalyst layer, and another porous carbon layer

In a preferred embodiment, the electrocatalyst composition of the present invention can be effectively used in a direct hydrogen peroxide fuel cell. In such a case it is preferred that the fuel is in contact with the anode and that the fuel is comprised of one or more of sodium borohydride, ammonia, azide, ethanol or methanol, guanidine, urea and lithium borohydride.

In the direct hydrogen peroxide fuel cell it is preferred that the fuel also contain a pH modifier comprised of one or more of a phosphate, borate, carbonate and ammonia.

Although the polymeric membrane can be formed of any inert polymer, it is preferred to employ a membrane comprised of NAFION, polyolefin, polyolefin coated with NAFION, acetate, or acetate and NAFION.

In a first preferred embodiment there is provided a fuel cell electrocatalyst composition comprising:

(a) one or more electrically conductive particles having an outer surface;

(b) one or more catalysts adhered and/or bonded to the outer surface of the particles, said catalysts comprised of a macrocycle and a metal.

In a second preferred embodiment there is provided in the first preferred embodiment a polymeric binder for the electyrocatalyst composition.

In a third preferred embodiment there is provided in the first preferred embodiment an electrocatalyst wherein the electrically conductive particles are comprised of one or more of carbon black, activated carbon, and graphite.

In a fourth preferred embodiment there is provided in the third preferred embodiment an electrocatalyst wherein the electrically conductive particles have a mean diameter of from about 0.1 μm to about 100 μm.

In a fifth preferred embodiment there is provided in the first preferred embodiment a macrocycle containing electrocatalyst wherein the macrocycles are comprised of one or more of acetylacetonate and phthalocyanine. The macrocycle can contain a metal atom, preferably a transition metal, and that the catalyst may also contain small amounts of another metal, preferentially chosen from the platinum group metals. Also any or all of the macrocycles may be pyrolysed.

In a sixth preferred embodiment there is provided in the first preferred embodiment an electrocatalyst wherein the metals are comprised of one or more of iron, nickel, zinc, scandium, titanium, vanadium, chromium, copper, platinum, ruthenium, rhodium, palladium, silver, osmium, iridium, platinum and gold.

In a seventh preferred embodiment there is provided in the first preferred embodiment an electrocatalyst wherein the catalyst is one or more of acetylacetonate, iron phthalocyanine, a complex or mixture of iron phthalocyanine and cobalt phthalocyanine, a complex or mixture of iron phthalocyanine and nickel phthalocyanine, a complex or mixture of iron phthalocyanine and platinum, a complex or mixture of iron phthalocyanine and cobalt acetylacetonate, and copper phthalocyanine.

In an eighth preferred embodiment there is provided in the first preferred embodiment an electrocatalyst wherein the electrically conductive particles comprise from about 1 wt % to about 90 wt % of the composition.

In a ninth preferred embodiment there is provided in the first preferred embodiment an electrocatalyst wherein the macrocycle comprises from about 5 wt % to about 25% of the composition.

In a tenth preferred embodiment there is provided in the first preferred embodiment an electrocatalyst wherein the catalyst metal comprises from about 0.05 wt % to about 1.0 wt % of the composition.

In an eleventh preferred embodiment there is provided in the second preferred embodiment an electrocatalyst wherein the electrically conductive particles and catalysts are blended with the polymer binder to form an electrocatalytic coating composition.

In a twelfth preferred embodiment there is provided a fuel cell membrane electrode assembly comprising:

(a) a first current collector;

(b) a second current collector disposed opposite the first current collector;

(c) a proton transfer membrane disposed between the first current collector and the second current collector; and

(d) an electrocatalyst layer comprising:
(i) one or more electrically conductive particles having an outer surface;
(ii) one or more catalysts adhered and/or bonded to the outer surface of the particles, said catalysts comprised of a macrocycle and a metal; and
(iii) a polymeric binder,

wherein the electrocatalyst layer is disposed on and/or adjacent to, and in communication with, one or more of the first current collector, second current collector and membrane.

In a thirteenth preferred embodiment there is provided in the twelfth preferred embodiment a fuel cell membrane electrode assembly wherein the electrically conductive particles are comprised of one or more of carbon black, activated carbon, and graphite.

In a fourteenth preferred embodiment there is provided in the twelfth preferred embodiment a fuel cell membrane electrode assembly wherein the electrically conductive particles have a mean diameter of from about 0.1 μm to about 100 μm.

In a fifteenth preferred embodiment there is provided in the twelfth preferred embodiment a fuel cell membrane electrode assembly wherein the macrocycles are comprised of one or more of acetylacetonate and phthalocyanine.

In a sixteenth preferred embodiment there is provided in the twelfth preferred embodiment a fuel cell membrane electrode assembly wherein the metals are comprised of one or more of iron, nickel, zinc, scandium, titanium, vanadium, chromium, copper, platinum, ruthenium, rhodium, palladium, silver, osmium, iridium, platinum and gold.

In a seventeenth preferred embodiment there is provided in the twelfth preferred embodiment a fuel cell membrane electrode assembly wherein the catalyst is one or more of acetylacetonate, iron phthalocyanine, a complex or mixture of iron phthalocyanine and cobalt phthalocyanine, a complex or mixture of iron phthalocyanine and nickel phthalocyanine, a complex or mixture of iron phthalocyanine and platinum, a complex or mixture of iron phthalocyanine and cobalt acetylacetonate, and copper phthalocyanine.

In an eighteenth preferred embodiment there is provided in the twelfth preferred embodiment a fuel cell membrane electrode assembly wherein the electrically conductive particles comprise from about 1 wt % to about 90 wt % of the composition, exclusive of any separate collector.

In a nineteenth preferred embodiment there is provided in the twelfth preferred embodiment a fuel cell membrane electrode assembly wherein the macrocycle comprises from about 5 wt % to about 25% of the composition.

In a twentieth preferred embodiment there is provided in the twelfth preferred embodiment a fuel cell membrane electrode assembly wherein the catalyst metal comprises from about 0.05 wt % to about 1.0 wt % of the composition.

In a twenty-first preferred embodiment there is provided in the twelfth preferred embodiment a fuel cell membrane electrode assembly wherein the electrically conductive particles and catalysts are blended with the polymer binder to form an electrocatalytic coating composition.

In a twenty-second preferred embodiment there is provided in the twelfth preferred embodiment a fuel cell membrane electrode assembly wherein the membrane is comprised of NAFION®, polyolefin, polyolefin coated with NAFION®, acetate, and acetate and NAFION®.

In a twenty-third preferred embodiment there is provided in connection with the twelfth preferred embodiment a direct hydrogen peroxide fuel cell comprising:

(a) an anode;

(b) a cathode disposed opposite the anode; and

(c) the fuel cell membrane electrode assembly of preferred embodiment twelve disposed between the anode and the cathode.

In a twenty-fourth preferred embodiment there is provided in the twenty-third preferred embodiment a direct hydrogen peroxide fuel cell further comprising:

(d) a fuel in communication with the anode, said fuel comprised of one or more of sodium borohydride, ammonium azide, ethanol, guanidine, and urea and lithium borohydride.

In a twenty-fifth preferred embodiment there is provided in the twenty-fourth preferred embodiment a direct hydrogen peroxide fuel cell which further comprises a pH modifier comprised of one or more of a phosphate, a borate, a carbonate, and an ammonia.

In a twenty-sixth preferred embodiment there is provided in the twenty-third preferred embodiment a direct hydrogen peroxide fuel cell which further comprises:

(e) an oxidant disposed in communication with the cathode, said oxidant comprised of hydrogen peroxide

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is an exploded perspective view of a fuel cell of the present invention showing main components of the fuel cell and an exploded view of the membrane electrode assembly according to the present invention.

FIG. 2 is a graph of voltage versus current and power versus current data collected for a fuel cell in Example 1 herein which was constructed according to the present invention.

FIG. 3 is a graph of voltage versus current and power versus current data collected for a fuel cell in Example 2 herein which was constructed according to the present invention.

FIG. 4 shows a graph of voltage versus current power versus current data collected for a fuel cell in Example 3 herein, which was constructed according to the present invention.

### DETAILED DESCRIPTION OF THE INVENTION

While the making and using of various embodiments of the present invention are discussed in detail above and below, it should be appreciated that the present invention provides many applicable inventive concepts that can be embodied in a wide variety of specific contexts. The terminology used and specific embodiments discussed herein are merely illustrative of specific ways to make and use the invention and do not delimit or restrict the scope of the invention.

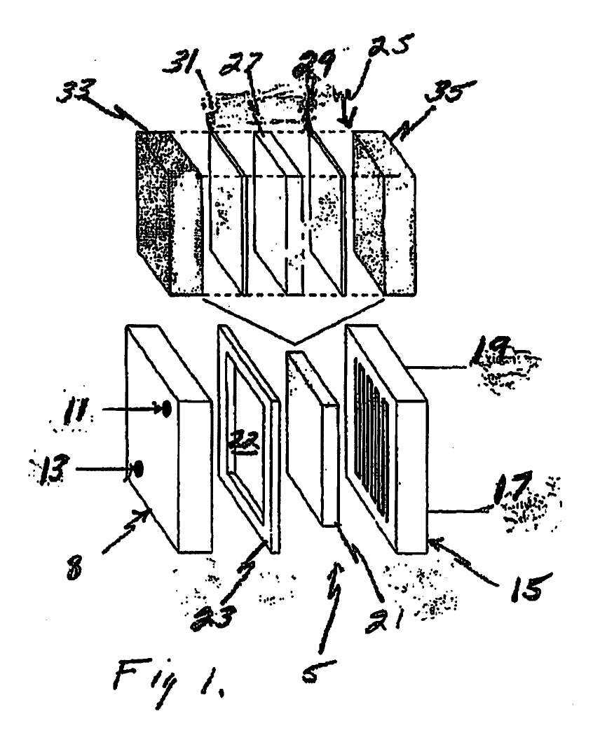

Referring to FIG. 1, a fuel cell shown generally in an exploded perspective view as 5 comprises an anode bipolar plate 8 having a fuel output port 11 and a fuel input port 13, a cathode bipolar plate 15 having an oxidant output port 17, and an oxidant input port 19. A membrane electrode assembly, shown generally at 21, is inserted in a hole 22 in gasket 23.

The exploded membrane assembly shown generally at 25 comprises a central member 27 having catalyst layers 29, 31 on both sides thereof, and first and second current collectors 33, 35 on both sides of the catalyst coated membrane 27. The membrane 27 is preferably comprised of NAFION®, polyolefin, polyolefin coated with NAFION®, acetate, or acetate and NAFION®.

In particular, electrocatalyst layers 29, 31 are disposed on and/or adjacent to, and in communication with, one or more of the first current collector 33, second current collector 35 and membrane 27. The electrocatalyst layers are comprised of an electrocatalyst composition containing electrically conductive particles, such as carbon black, activated carbon, and graphite, having a mean diameter of from about 0.1 μm to about 100 μm. These electrically conductive particles comprise from about 1 wt % to about 90 wt % of the electrocatalyst composition.

One or more catalysts are adhered and/or bonded to the outer surface of the particles. The catalysts are comprised of one or more macrocycles, such as acetylacetonate and phthalocyanine. The macrocycle comprise from about 5 wt % to about 25 wt % of the electrocatalyst composition, based on total weight of the electrocatalyst composition.

In addition, the electrocatalyst composition contains one or more metals. These metals include iron, nickel, zinc, scandium, titanium, vanadium, chromium, copper, platinum, ruthenium, rhodium, palladium, silver, osmium, iridium, platinum and gold. In a preferred embodiment, the catalyst is one or more of acetylacetonate, iron phthalocyanine, a complex or mixture of iron phthalocyanine and cobalt phthalocyanine, a complex or mixture of iron phthalocyanine and nickel phthalocyanine, a complex or mixture of iron phthalocyanine and platinum, a complex or mixture of iron phthalocyanine and cobalt acetylacetonate, and copper phthalocyanine. The catalyst metal comprises from about 0.05 wt % to about 1.0 wt % of the electrocatalyst composition, based on total weight thereof.

In order to form a composition capable of being coated/adhered to a surface, in a preferred embodiment, the electrocatalyst composition is blended with a polymeric binder to form an electrocatalytic coating composition. In practice, any conventional polymer binder can be used which does not interfere with the catalytic activity of the electrocatalyst of the present invention.

The invention will be further understood with reference to the following examples, it being understood that these examples are intended to illustrate the present invention without limiting the scope thereof in any fashion.

### EXAMPLE 1

### 4 by 4 Inch Fuel Cell

A 4.0 inch by 4.0 inch fuel cell was constructed with a cathode opposite an anode, and a membrane electrode assembly disposed between the cathode and anode. The cathode and anode are made up of graphite plates approximately one-inch thick with a machined serpentine flow path on one side of the plate.

The fuel cell membrane electrode assembly was composed of a first current collector with a second current collector disposed opposite the first, both being made from a porous carbon paper having a thickness of 0.005 inch, and a proton transfer membrane 0.002 inch thick NAFION® was disposed between the first and second current collectors. An electrocatalyst layer ranging in thickness between 0.0005 and 0.002 inches was disposed on the current collector and adjacent to the proton transfer membrane.

This electrocatalyst layer was comprised of electrically conductive particles in a mixture of carbon black, activated carbon, and graphite. The catalysts were comprised of iron phthalocyanine and copper phthalocyanine, and a polymeric binder was comprised of polyvinyl diene fluoride. The catalysts comprised 12.0% by weight of the electrocatalyst layer. The electrocatalyst layer adjacent to the anode had a catalyst comprised of iron phthalocyanine, whereas the electrocatalyst layer adjacent to the cathode was comprised of copper phthalocyanine.

The catalyst was made of a metal and a macrocycle, where iron was the metal on the anode, copper the metal on the cathode side, and phthalocyanine the macrocycle for both catalysts. A gasket consisting of 0.010 inch thick Teflon was positioned around the current collector and in between the plates and membrane in order to seal the reactants inside the fuel cell. The fuel cell was secured together with bolts. The oxidant used on the cathode side of the fuel cell was 10% by weight of hydrogen peroxide, the remaining part being water. The fuel in communication with the anode was 10% by weight sodium borohydride in water. The fuel also had a pH modifier of sodium hydroxide added in a ratio of 6.31 g NaBH₄:1.00 g NaOH. The remaining part of the fuel was comprised of water. The fuel and oxidant were pumped through the cell using a peristaltic pump.

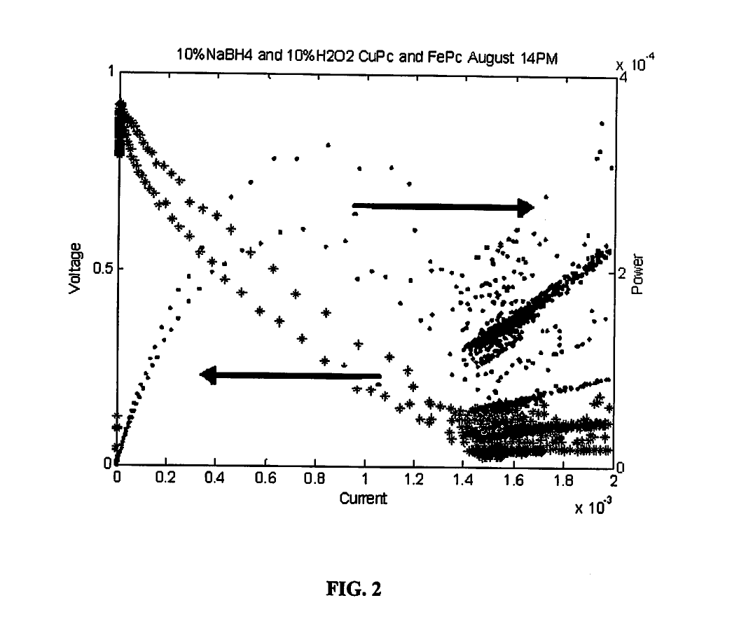

A digital multimeter and oscilloscope were used to measure the current, power, and voltage data. FIG. 2 shows a graph of Voltage vs. Current and Power vs. Current data collected using this fuel cell and the collected data. The peak power output for this test, as seen in FIG. 2, was 3.5 mW/cm² at 0.4 volts, and the open circuit voltage for the cell was 0.85 volts.

This example shows that a single cell using the described electrocatalyst layer, hydrogen peroxide oxidant and sodium borohydride fuel had a polarization curve resembling that of a fuel cell. This data also demonstrates that a single cell can maintain a constant power output under a constant load.

### EXAMPLE 2

### 3 by 6.5 Inch Fuel Cell Stack

A 3.0 inch by 6.5 inch fuel cell was constructed with a cathode opposite an anode, and a membrane electrode assembly disposed between the cathode and anode. Twelve (12) of these cells were positioned back to back to make up an entire fuel cell stack. The cathode and anode were made of graphite plates approximately 0.25 inches in thickness with a machined serpentine flow path on one side of the plate.

The fuel cell membrane electrode assembly was comprised of a first current collector with a second current collector disposed opposite the first, both being made from a porous carbon paper with a 0.005 inch thickness, and a proton transfer membrane 0.002 inch thick NAFION® was disposed between the first and second current collectors. An electrocatalyst layer between 0.0005 and 0.002 inches in thickness was disposed on the current collector adjacent to the proton transfer membrane.

This electrocatalyst layer was comprised of electrically conductive particles in a mixture of carbon black, activated carbon, and graphite. The catalyst was comprised of iron phthalocyanine and copper phthalocyanine, and a polymeric binder comprised of polyvinyl diene fluoride. The catalysts comprised 14.0% of the electrocatalyst layer. The electrocatalyst layer adjacent to the anode had a catalyst comprised of iron phthalocyanine, whereas the electrocatalyst layer adjacent to the cathode had a catalyst comprised of copper phthalocyanine. The catalyst was made of a metal and a macrocycle, where the iron and copper was the metal and the phthalocyanine was the macrocycle.

A gasket consisting of 0.005 inch thick Teflon was positioned around the current collector and in between the plates and membrane in order to seal the reactants inside the fuel cell. The fuel cell was secured together with bolts.

The oxidant used on the cathode side of the fuel cell was 5% by weight of hydrogen peroxide, the remainder being water. The fuel in communication with the anode was 5% by weight of sodium borohydride. The fuel also had a pH modifier of sodium hydroxide present in a ratio of 6.31 g NaBH₄:1.00 g NaOH. The remaining part of the fuel was comprised of water. Fuel and oxidant were pumped through the cell using a peristaltic pump.

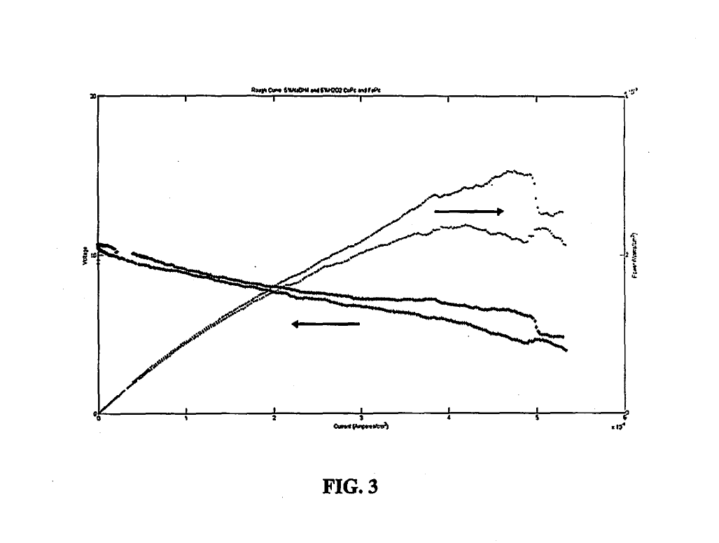

A digital multimeter and oscilloscope were used to measure the current, power, and voltage data. FIG. 3 shows a graph of Voltage vs. Current and Power vs. Current data collected using this fuel cell and the collected data. The peak power output for this test, as seen in FIG. 3, was 3.0 m W/cm² at a total stack voltage of 4.0 volts and an open circuit voltage for the fuel stack was 10.5 volts, or 0.875 volts per cell.

This example shows that a stack of cells using the above-described electrocatalyst layer, hydrogen peroxide oxidant, and sodium borohydride fuel, produces the same output per cell as a single cell system. Therefore, this system can be scaled up without the loss of any efficiency and power per cell.

### EXAMPLE 3

### 3 by 6.5 Inch Fuel Cell Stack

A 3.0 by 6.5 inch fuel cell was constructed with a cathode opposite an anode, and a membrane electrode assembly disposed between the cathode and anode. Twelve (12) of these cells were positioned back to back, anode side to cathode side, to form an entire fuel cell stack. The cathode and anode were made of graphite plates approximately 0.25 inches thick with a machined serpentine flow path on one side of the plate.

The fuel cell membrane electrode assembly was comprised of a first current collector with a second current collector disposed opposite the first, both being made from a porous carbon paper having a thickness of 0.005 inches, and a proton transfer membrane of 0.002 inch thick NAFION® was disposed between the first and second current collectors. An electrocatalyst layer ranging between 0.0005 and 0.002 inches thick was disposed on the current collector and adjacent to the proton transfer membrane.

This electrocatalyst layer was comprised of electrically conductive particles in a mixture of carbon black, activated carbon, and graphite. The catalysts were comprised of iron phthalocyanine and copper phthalocyanine, and a polymeric binder comprised of a polyvinyl diene fluoride. The catalysts comprised 12.5% by weight of the electrocatalyst layer. The electrocatalyst layer adjacent to the anode had the catalyst comprised of iron phthalocyanine, whereas the electrocatalyst layer adjacent the cathode had a catalyst comprised of copper phthalocyanine. The catalyst was made of a metal and a macrocycle, where the metal was iron and copper, and the macrocycle was phthalocyanine.

A gasket consisting of 0.005 inch thick Teflon was positioned around the current collector and in between the plates and membrane in order to seal the reactants inside the fuel cell. The fuel cell was then secured together with bolts.

The oxidant used on the cathode side of the fuel cell was 5% by weight hydrogen peroxide with a pH modifier of sulfuric acid being added to make the solution 0.25 M H₂SO₄. The remaining part of the oxidant was comprised of water. The fuel in communication with the anode was 5% by weight of sodium borohydride. The fuel also had a pH modifier of sodium hydroxide added in the ratio of 6.31 g NaBH₄:1.00 g NaOH. The remaining part of the fuel was water. The fuel and oxidant were pumped through the cell using a peristaltic pump.

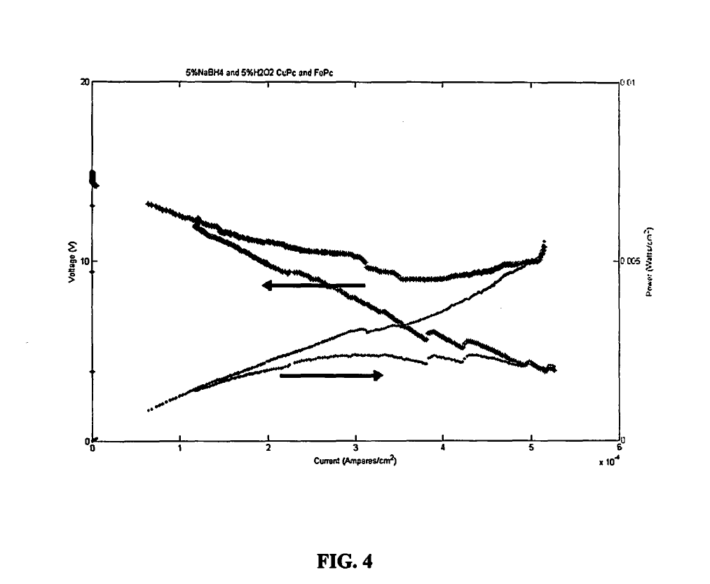

A digital multimeter and oscilloscope were used to measure the current, power, and voltage data. FIG. 4 shows a graph of Voltage vs. Current and Power vs. Current data collected using this fuel cell and the collected data. The peak power output for this test, as seen in FIG. 4, was 5.0 mW/cm² at a total stack voltage of 5.0 volts and an open circuit voltage per cell of 1.25 volts.

This example shows that a stack of cells using the above-described electrocatalyst layer, hydrogen peroxide oxidant, and a sodium borohydride fuel had an improved power output when a hydrogen peroxide pH modifier was added.

Although specific embodiments of the present invention have been disclosed herein, those having ordinary skill in the art will understand that changes can be made to the specific embodiments without departing from the spirit and scope of the invention. Thus, the scope of the invention is not to be restricted to the specific embodiments. Furthermore, it is intended that the appended claims cover any and all such applications, modifications, and embodiments within the scope of the present invention

[symbol]

What is claimed is:

1. A fuel cell electrocatalyst composition comprising:
(a) one or more electrically conductive particles having an outer surface;
(b) one or more catalysts adhered and/or bonded to the outer surface of the particles, said catalysts comprised of a macrocycle and a metal.

2. The fuel cell electrocatalyst composition of claim 1, further comprising:
(c) a polymeric binder.

3. The fuel cell electrocatalyst composition of claim 1, wherein the electrically conductive particles are comprised of one or more of carbon black, activated carbon, and graphite.

4. The fuel cell electrocatalyst composition of claim 3, wherein the electrically conductive particles have a mean diameter of from about 0.1 μm to about 100 μm.

5. The fuel cell electrocatalyst composition of claim 1, wherein the macrocycles are comprised of one or more of acetylacetonate and phthalocyanine.

6. The fuel cell electrocatalyst composition of claim 1, wherein the metals are comprised of one or more of iron, nickel, zinc, scandium, titanium, vanadium, chromium, copper, platinum, ruthenium, rhodium, palladium, silver, osmium, iridium, platinum and gold.

7. The fuel cell electrocatalyst composition of claim 1, wherein the catalyst is one or more of acetylacetonate, iron phthalocyanine, a complex or mixture of iron phthalocyanine and cobalt phthalocyanine, a complex or mixture of iron phthalocyanine and nickel phthalocyanine, a complex or mixture of iron phthalocyanine and platinum, a complex or mixture of iron phthalocyanine and cobalt acetylacetonate, and copper phthalocyanine.

8. The fuel cell electrocatalyst composition of claim 1, wherein the electrically conductive particles comprise from about 1 wt % to about 90 wt % of the composition.

9. The fuel cell electrocatalyst composition of claim 1, wherein the macrocycle comprises from about 5 wt % to about 25% of the composition.

10. The fuel cell electrocatalyst composition of claim 1, wherein the catalyst metal comprises from about 0.05 wt % to about 1.0 wt % of the composition.

11. The fuel cell electrocatalyst composition of claim 2, wherein the electrically conductive particles and catalysts are blended with the polymer binder to form an electrocatalytic coating composition.

12. A fuel cell membrane electrode assembly comprising:
(a) a first current collector;
(b) a second current collector disposed opposite the first current collector;
(c) a proton transfer membrane disposed between the first current collector and the second current collector; and
(d) an electrocatalyst layer comprising:
(i) one or more electrically conductive particles having an outer surface;
(ii) one or more catalysts adhered and/or bonded to the outer surface of the particles, said catalysts comprised of a macrocycle and a metal; and
(iii) a polymeric binder,
wherein the electrocatalyst layer is disposed on and/or adjacent to, and in communication with, one or more of the first current collector, second current collector and membrane.

13. The fuel cell membrane electrode assembly of claim 12, wherein the electrically conductive particles are comprised of one or more of carbon black, activated carbon, and graphite.

14. The fuel cell membrane electrode assembly of claim 12, wherein the electrically conductive particles have a mean diameter of from about 0.1 μm to about 100 μm.

15. The fuel cell membrane electrode assembly of claim 12, wherein the macrocycles are comprised of one or more of acetylacetonate and phthalocyanine.

16. The fuel cell membrane electrode assembly of claim 12, wherein the metals are comprised of one or more of iron, nickel, zinc, scandium, titanium, vanadium, chromium, copper, platinum, ruthenium, rhodium, palladium, silver, osmium, iridium, platinum and gold.

17. The fuel cell membrane electrode assembly of claim 12, wherein the catalyst is one or more of acetylacetonate, iron phthalocyanine, a complex or mixture of iron phthalocyanine and cobalt phthalocyanine, a complex or mixture of iron phthalocyanine and nickel phthalocyanine, a complex or mixture of iron phthalocyanine and platinum, a complex or mixture of iron phthalocyanine and cobalt acetylacetonate, and copper phthalocyanine.

18. The fuel cell membrane electrode assembly of claim 12, wherein the electrically conductive particles comprise from about 1 wt % to about 90 wt % of the composition, exclusive of any separate collector.

19. The fuel cell membrane electrode assembly of claim 12, wherein the macrocycle comprises from about 5 wt % to about 25% of the composition.

20. The fuel cell membrane electrode assembly of claim 12, wherein the catalyst metal comprises from about 0.05 wt % to about 1.0 wt % of the composition.

21. The fuel cell membrane electrode assembly of claim 12, wherein the electrically conductive particles and catalysts are blended with the polymer binder to form an electrocatalytic coating composition.

22. The fuel cell membrane electrode assembly of claim 12, wherein the membrane is comprised of NAFION®, polyolefin, polyolefin coated with NAFION®, acetate, and acetate and NAFION®.

23. A direct hydrogen peroxide fuel cell comprising:
(a) an anode;
(b) a cathode disposed opposite the anode; and
(c) the fuel cell membrane electrode assembly of claim 12 disposed between the anode and the cathode.

24. The direct hydrogen peroxide fuel cell of claim 23, further comprising:
(d) a fuel in communication with the anode, said fuel comprised of one or more of sodium borohydride, ammonium azide, ethanol, guanidine, and urea and lithium borohydride.

25. The direct hydrogen peroxide fuel cell of claim 24, said fuel further comprises a pH modifier comprised of one or more of a phosphate, a borate, a carbonate and an ammonia.

26. The direct hydrogen peroxide fuel cell of claim 23, further comprising:
(e) an oxidant disposed in communication with the cathode, said oxidant comprised of hydrogen peroxide.
